(19) United States
(12) Patent Application Publication
(10) Pub. No.: US 2011/0090166 A1
(43) Pub. Date: Apr. 21, 2011

(54) METHOD AND APPARATUS FOR USING DIFFERENT GRAPHICAL DISPLAY TECHNOLOGIES TO ENABLE USER INTERACTIVITY

(75) Inventor: PIETER TRUTER, Vancouver (CA)

(73) Assignee: Barnes & Noble, Inc., New York, NY (US)

(21) Appl. No.: 12/907,935

(22) Filed: Oct. 19, 2010

Related U.S. Application Data
(60) Provisional application No. 61/252,817, filed on Oct. 19, 2009.
(60) Provisional application No. 61/253,447, filed on Oct. 20, 2009.

(51) Int. Cl. G06F 3/041; G06F 3/048; G06F 3/038; G09G 3/36

(52) U.S. Cl. 345/173; 715/764; 345/211; 345/87; 345/88; 345/104

(57) ABSTRACT

An electronic device comprising an electronic paper display that displays a first set of data, and a second display that displays a portion of the first set of data displayed on the electronic paper display. Preferably, the second display is a Liquid Crystal Display and displays the portion of the first set of data in color, whereas the portion is displayed on the electronic paper display in monochrome.

### CROSS-REFERENCE TO RELATED APPLICATION

This application claims the benefit of U.S. Provisional Application No. 61/252,817, filed Oct. 19, 2009, and U.S. Provisional Application No. 61/253,447, filed Oct. 20, 2009, which are hereby incorporated by reference.

### FIELD OF INVENTION

The present patent document relates to graphical display processing and in particular, to graphical display processing for disparate graphical display technologies.

### BACKGROUND OF THE INVENTION

The electronics we use today, in particular the mobile gadgets we carry with us, are expanding to include more and more functionality. In particular, specialized technologies are being developed to solve specific problems associated with certain electronic components.

One example is the development of new screen types. Numerous new display technologies offer advantages that cannot be duplicated by other display technologies.

One such example is the recent improvements in displays based on reflective technologies such as electronic paper displays (EPDs). Displays based on reflective technologies offer advantages that cannot be duplicated by displays that are backlit such as liquid crystal displays (LCD). For example, EPDs may be easily viewed in the presence of large amounts of ambient light such as sunlight and EPDs are less tiring on the eyes after extensive viewing.

However presently, EPDs are monochrome, slow to update, and have optical qualities that are adversely affected by applying a touch-sensitive layer on top of them. Because interactive layers such as touch screens do not work with EPDs, it is not possible to access control elements from an external input. For example it is difficult to implement control elements such as Graphical User Interface (GUI) buttons, in an electronic paper display to select a command to invoke an action, such as click a hyperlink or play a movie. Electronic paper displays may be adequate for static, passive reading activities, but are not designed well for interactive use.

### BRIEF SUMMARY OF THE INVENTION

In view of the foregoing, an object according to one aspect of the present patent document is to provide an improved apparatus and process for using different graphical display technologies to enable user interactivity. Preferably the apparatus and processes address, or at least ameliorate one or more of the problems described above. To this end, an electronic device is provided; the electronic device comprises: an electronic paper display coupled to the device; and a second display coupled to the device, wherein the second display is configured to display a portion of the electronic paper display.

In certain embodiments, the second display is a liquid crystal display. The liquid crystal display may further be a touch screen display. The liquid crystal display may also be a color display.

In another embodiment, the second display is configured to allow the electronic paper display to be panned via input on the second display.

In yet another embodiment, the electronic device is a portable handheld device although in other embodiments the device is not required to be portable or handheld.

In other embodiments of the electronic device, the second display is used to show an enlarged view of the electronic paper display.

In another embodiment, a user interface may be further overlaid on the second display. The user interface may be used to allow user input to the electronic device.

In other embodiments, the electronic paper display and the second display are connected, coupled, attached, or configured on the electronic display in any number of ways. For example, the electronic device may further comprise a frame and the electronic paper display and the second display are encased by the frame.

In another embodiment, a process for incorporating different graphic display technologies on an electronic device is provided, the process comprises the steps of: manufacturing an electronic device with an electronic paper display and a second display based on a different graphical technology from the electronic paper display, and configuring the device to display a portion of the electronic paper display within the second display.

In one embodiment, the process includes further configuring the device to include a graphical user interface overlaid on the second display. In another embodiment of the process provided, the second display is a liquid crystal display. In further embodiments, the liquid crystal display may be a touch screen display or a color display. The process may occur in the manufacture of a handheld portable device or other devices.

In yet another embodiment, the device is further configured to allow the electronic paper display to be panned via input on the second display.

In another embodiment, the device is further configured to display the portion of the electronic paper display in an enlarged view on the second display.

In one embodiment, the device is further configured to use a single buffer that spans the electronic paper display and the second display.

### BRIEF DESCRIPTION OF DRAWINGS

FIG. 1 shows a top view of a dual-display electronic device 100 with a frame buffer that spans the display area of both displays.

FIG. 2a shows a conceptual top view of a dual-display electronic device 200 where the content of graphical data in a frame buffer is displayed in a primary graphical display.

FIG. 2b shows a conceptual top view of a dual-display electronic device 200 where the content of graphical data in a frame buffer is displayed in a primary graphical display and a portion of graphical data is displayed in the secondary graphical display of the device.

FIG. 2c shows a conceptual top view of a dual-display electronic device 200 where the content of graphical data in the secondary graphical display is different from FIG. 2b because a different content portion of the data is scrolled into view in the secondary graphical display of the device.

### DETAILED DESCRIPTION

One embodiment of this invention provides an electronic display device with dual graphical displays based on disparate graphical display technologies, where the technology of one graphical display enables a richer interaction with the digital content delivered from a display buffer to both graphical displays. Another embodiment of this invention provides an electronic display device with a separate, secondary window which a user may employ to interact with data in the primary display. Selecting a portion of data displayed in a secondary window through a touch or drag interface allows a user to interact with data in the primary display.

Allowing a user to interact with data in the primary display via the secondary display is especially important when the primary display is of a type that is not well suited to accept user interaction. For example, a display buffer containing information for a primary electronic paper display might contain information, such as color data or rapidly changing data, which cannot be output directly to the primary display. Consequently, some conversion exists that modifies or reduces that information (e.g., color to monochrome conversion) before the information is passed to the primary display. Unlike the primary display which may have limited display or interactive capabilities a secondary color LCD display can display the source data in its entirety.

In various embodiments, the primary display may include different limitations that require data conversion from the display buffer and make a secondary display advantageous. For example, the data in the display buffer may need to be reduced in resolution to properly display on the primary display. As another example the primary display may not have a sufficiently high refresh rate and the data in the buffer may need a reduction in the rate at which it is displayed. For example, an electronic paper display may not be able to display full motion video. In such an embodiment, a secondary LCD display may be included which can display full motion video at full rate.

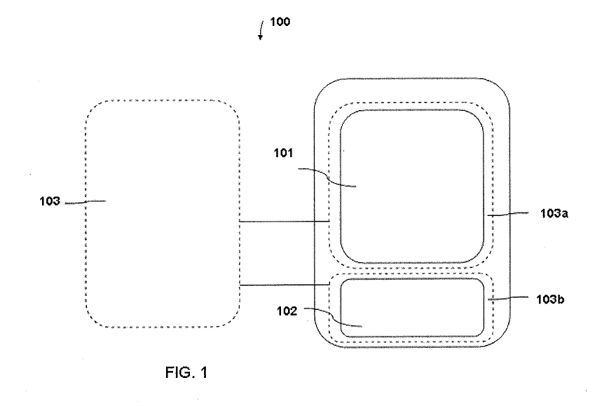

FIG. 1 shows a top view of a dual-display electronic device 100 comprised of two separate physical displays based on different technologies. The two separate physical displays are primary display 101 and secondary display 102. Frame buffer 103 is a single frame buffer that spans the combined display areas of primary display 101 and secondary display 102. Primary display 101 displays graphical data 103a, which consists of data rendered in frame buffer 103 but modified, filtered, or transformed to meet the underlying display technology of primary display 101. When modified, filtered or transformed, the quality and capabilities of the rendered data are reduced in graphical data 103a. For example, frame buffer 103 may include color attributes for graphical data, but color attributes are filtered out in graphical data 103a in order to be displayed in a monochrome primary display 101. In other embodiments, other display properties may be modified such as resolution or refresh rate to name a few.

Secondary display 102 has underlying display technology that is different from primary display 101. Secondary display 102 shows graphical data 103b, which consists of data rendered in frame buffer 103. The quality and capabilities of data rendered in frame buffer 103 is not reduced in graphical data 103b. Graphical data 103b is richer than graphical data 103a. Graphical data 103b may or may not be additionally processed to meet the display requirements of the underlying display technology of secondary display 102. That is, the format of graphical data 103b may be the same format as data rendered in frame buffer 103. For example, primary display 101 could be a monochrome Electronic Paper Display (EPD) and secondary display 102 could be a color Liquid Crystal Display (LCD). The format of data rendered into frame buffer 103 could be the same format used by the LCD. In this example, if frame buffer 103 has color data, graphical data 103a displayed in primary display 101 has color attributes filtered out on the monochrome EPD. Graphical data 103b displayed in secondary display 102, however, retains the color attributes and is displayed in color on the color LCD.

The underlying display technology of secondary display 102 provides a means to deliver coordinate information to its physical display. One embodiment of delivering coordinate information to secondary display 102 could be touch-sensitive input from a user, such as drag or gesture. A second embodiment of delivering coordinate information to secondary display 102 could be touch-sensitive navigation input from a separate control input mechanism, such as a stylus.

A preferred embodiment of the invention is that secondary display 102 is touch sensitive, and through touch-sensitive input, allows graphical data 103b to be scrolled up, down, left, and right. A user can interact with secondary display 102 to scroll or pan around graphical data 103b. By using secondary display 102 to scroll or pan in this manner, a user has greater capabilities in 102 to interact with the same content that is available in physical display 101.

Embodiments of the invention are not intended to be limited to scrolling and panning. In other embodiments, manipulations such as zoom in and zoom out to facilitate changing font size or resolution are included. In addition, although secondary display 102 can be referred to as “zoom display”, secondary display 102 is not required to zoom. In addition, other important manipulations may be present in other embodiments such as interaction with user interface elements. User interface elements may consist of graphical buttons, lists, or other graphic interface controls.

In operation of the embodiment shown in FIG. 1, if a user desires to interact with a user interface control that is located on the primary display 101, the user may pan and/or zoom the field of view of secondary display 102 so that the interactive element is within the field of view of the secondary display 102. The user may then interact with the control element by manipulating it in secondary display 102. For example, touching it in embodiments that include a touch sensitive secondary display 102. This process may be repeated for the next interactive element.

A preferred embodiment of the invention is that frame buffer 103 is of the same graphical format as secondary display 102. This graphical format can be post-processed into the format of primary display 101. When frame buffer 103 is of the same graphical format as secondary display 102, display 102 can be panned instantly merely by changing the pointer location of the secondary display 102 source.

A preferred embodiment of the invention is that the underlying display technology of secondary display 102 allows for color. This allows any underlying color data filtered out from graphical data 103a targeted to primary display 101 to be revealed in color when graphical data 103b is viewed in secondary display 102. Color capability for secondary display 102 is especially preferred to improve usability where primary display 101 is monochrome, such as in EPDs.

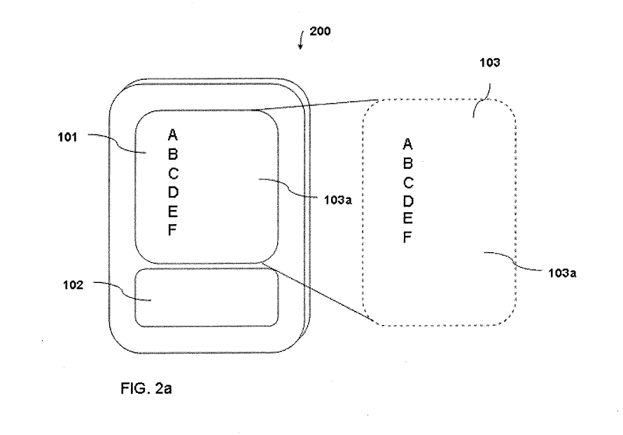

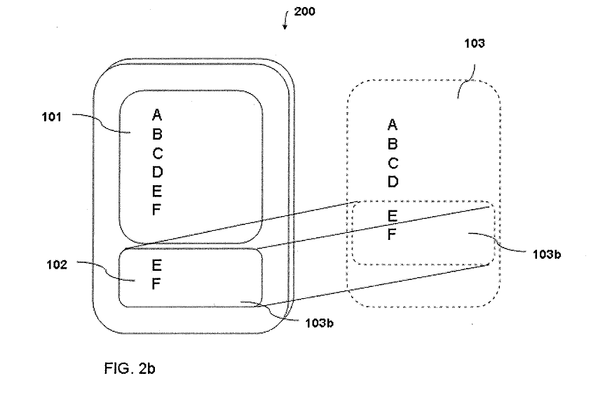

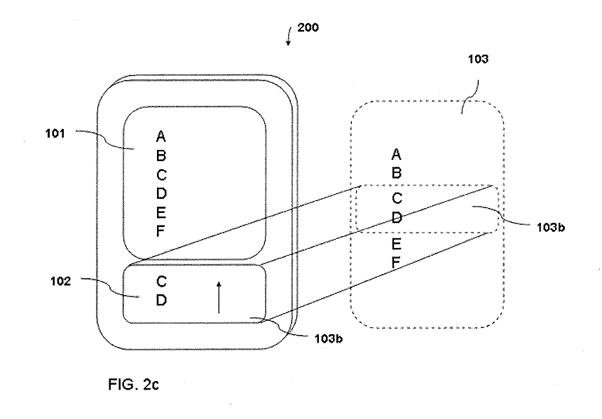

FIG. 2a shows exemplary graphical data rendered in frame buffer 103 spanning the combined areas of primary display 101 and secondary display 102. Graphical data 103a has the same content as frame buffer 103, but graphical data 103a is filtered to meet the underlying display technology of primary display 101.

FIG. 2b also shows exemplary graphical data rendered in frame buffer 103, where a subset of the same content of 103 is displayed as graphical data 103b in secondary display 102.

In one embodiment, secondary display 102 is further configured to allow user interaction with the graphical data through the secondary display 102. The preferred embodiment of secondary display 102 is a touch screen. A user may engage with the touch screen of secondary display 102 to interact with graphical data 103b. Because graphical data 103b is a subset of graphical data 103, the secondary display 102 allows a user to effectively interact with the graphical data displayed on the primary display 101 via the secondary display 102.

In the embodiment shown in FIG. 2c, when a user drags or scrolls the touch screen of secondary display 102, a portion of graphical data correspondingly moves along the surface area of secondary display 102 to the coordinates of the desired location. By zooming or panning within the secondary display 102, the user changes the field of view of the secondary display 102 to a different portion of the primary display 101. As such, secondary display 102 serves as a window into all the content rendered in frame buffer 103 and displayed as filtered graphical data 103a in primary display 101. Because all the content is essentially the same in frame buffer 103, primary display 101, and secondary display 102, a user can use the technological capabilities of secondary display 102 to access and interact with the content displayed as graphical data 103a in primary display 101. Because graphical data 103b in secondary display 102 is not filtered like graphical data 103a, a user may have greater technological capabilities for interacting with content via secondary display 102.

For example, in the case where primary display 101 includes a GUI element linked to an underlying control, e.g., a GUI button, a user can access and interact with the control by engaging with secondary display 102.

Although the data illustrated as residing in frame buffer 103 has been illustrated in FIGS. 2a-2c as being sequential and related, this is not a requirement of the present invention. For example, the data for display in primary display 101 could be text data for an eBook, while unrelated graphical data from an Internet browser or an email application could be displayed on secondary display 102.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An electronic device comprising:
an electronic paper display that is configured to display a first set of data; and
a second display that is configured to display a portion of the first set of data that is displayed on the electronic paper display.

2. The electronic device of claim 1, wherein the second display is a liquid crystal display.

3. The electronic device of claim 2, wherein the liquid crystal display is a touch screen display.

4. The electronic device of claim 2, wherein the liquid crystal display is a color display.

5. The electronic device of claim 1, wherein the electronic paper display is configured to be panned by input received on the second display.

6. The electronic device of claim 1, wherein the electronic device is a handheld portable device.

7. The electronic device of claim 1, wherein the portion of the electronic paper display is enlarged on the second display.

8. The electronic device of claim 1, wherein a user interface is overlaid on the second display.

9. The electronic device of claim 1, further comprising a frame, wherein the electronic paper display and the second display are encased by the frame.

10. The electronic device of claim 1, further comprising a display buffer coupled to the electronic paper display and coupled to the second display.

11. The electronic device of claim 10, wherein the display buffer contains source data, wherein the source data is modified to create the first set of data for display on the electronic paper display and not modified to create the portion of the first set of data displayed on the second display.

12. The electronic device of claim 11, wherein the first set of data is monochromatic and the portion of the first set of data displayed on the second display is in color.

13. A process for incorporating different graphic display technologies on an electronic device, the process comprising the acts of:
configuring an electronic paper display to display a first set of data
configuring a second display having different graphical technology from the electronic paper display to display a portion of first set of data displayed on the electronic paper display.

14. The process according to claim 13, wherein the second display is a liquid crystal display.

15. The process according to claim 13, further comprising configuring the electronic device to allow the electronic paper display to be panned via input on the second display.

16. The process according to claim 13, further comprising overlaying a user interface on the second display.

17. The process according to claim 13, further comprising:
providing a display buffer containing source data;
modifying the source data to create the first set of data; and
displaying unmodified source data on the second display.

18. The process according to claim 13, wherein the first set of data is monochromatic and the portion of the first set of data displayed on the second display is in color.

19. The process according to claim 13, further comprising accepting user input on the second display.

20. An electronic device comprising:
a display buffer containing source data;
an electronic paper display coupled to the display buffer and receiving a first set of data for display on the electronic paper display; and
a second display coupled to the display buffer and receiving source data that corresponds to a portion of the first set of data that is displayed on the electronic paper display, the second display displaying the received source data.
